(19) United States
(12) Patent Application Publication
(10) Pub. No.: US 2009/0228773 A1
(43) Pub. Date: Sep. 10, 2009

(54) Interactive information and ordering device

(76) Inventors: Jennifer M. Hedges, Fisherville, KY (US); Michael D. Hedges, Fisherville, KY (US)

Correspondence Address: David E. Orr, 4616 NE 134th Street, Vancouver, WA, 98686, US

(21) Appl. No.: 12/074,535

(22) Filed: Mar. 5, 2008

(51) Int. Cl. G06F 17/00

(52) U.S. Cl. 715/200

(57) ABSTRACT

An interactive device comprising a pliable or flexible page having at least one grouping of text and/or graphics, wherein the page may be constructed of paper, plastic or laminated material. Associated with each grouping, there is a pressure-sensitive transmitter activated by a person touching or pressing a location on the page, the location associated with the grouping. The transmitter sends a first signal that identifies the grouping. Also on the page, or on another page or somewhere away from the device, a receiver-responder emits processes data and emits a second signal responsive to the first signal. The receiver-responder may send a signal, such as a sound or an image that is displayed or played on an output on the page.

### FIELD

The present invention relates to hybrid documents having electronic components; more specifically the present invention is an interactive device for presenting information about articles for sale, for describing articles for sale and for facilitating ordering of articles for sale. In an exemplary embodiment, the device is disclosed as an interactive menu used in a restaurant, wherein the menu answers questions and assists in ordering and rendering a bill.

### BACKGROUND

The word menu, like much of the terminology of cuisine, is French in origin. It ultimately derives from Latin minutus, something made small; in French it came to be applied to a detailed list or résumé of any kind. The original menus that offered consumers choices were prepared on a small chalkboard, in French a carte; so foods chosen from a bill of fare are described as á la carte, “according to the board.”

The original restaurants had no menus in the modem sense; these table d'hôte establishments served dishes that were chosen by the chef or the proprietors, and those who arrived ate what the house was serving that day, as in contemporary banquets.

The contemporary menu first appeared in the second half of the eighteenth century. Here, instead of eating what was being served from a common table, restaurants allowed diners to choose from a list of unseen dishes, which were produced to order by the customer's selection. A table d'hôte establishment charged its customers a fixed price; the menu allowed customers to spend as much or as little money as they chose.

In summary menus have not changed for hundreds of years, even with major advances in computer technology. What is needed and has not been available are menus or lists or resumes that are more informative, communicating with a customer using human compatible and human preferred modes of communications.

### OBJECTS

In view of the efficacy of a human communications mode oriented device for information transfer and for ordering items, herein is disclosed a device that may communicate by sound and by image with a customer. The device is disclosed as a flat substrate having embedded within electronic components that may be invoked by a customer or user, wherein the component transmits pre-recorded sounds and images.

A second object is a menu that may be used to present items in a restaurant, wherein the customer may hear information about a menu item that interests the customer.

Another object and advantage is a device that may reside on an item for sale, and upon tactile selection by a customer conveys images and sound related to the item.

Another object is a an interactive catalog that, when prompted by a customer, conveys sounds and image to the customer.

Other benefits and advantages of the invention will appear from the disclosure to follow. In the disclosure reference is made to the accompanying drawings, which form a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### SUMMARY

According to the objects of the present invention, herein is disclosed in an exemplary embodiment, an intelligent interactive menu used in a restaurant, catalog store, car dealership, coffee shop or the like. In the exemplary embodiment the invention is disclosed as a device comprising a readable menu having at least one pliant page, which may be turned or folded to be tangent to at least one pliant page. Each page of the menu may have text and/or graphics describing a product, item for sale or service offered. In close proximity to the text and/or graphics, the page may have embedded within or fixed upon a pressure sensitive electric or mechanical object configured as a touch transmitter that when touched or pressed emits a first signal associated with the text or graphics. Within the menu page, a first touch-signal receiver-sound generator receives the touch signal and emits a sound associated with the first signal. Within the menu page a second type touch receiver transmits a second touch signal when pressed, the second touch signal associated with text or graphics on the page. Elsewhere a second receiver receives the second touch signal and processes or stores data associated with the second touch signal. Data associated with the second signal may be used to order a product or service and may be used to render a bill for the order.

### BRIEF DESCRIPTION OF THE DRAWINGS

FIG. 1 illustrates a general computing environment for practicing the invention.

FIG. 2 shows a general embodiment.

FIG. 3 illustrates an exemplary embodiment as a restaurant menu.

### DETAILED DESCRIPTION

The present invention is practiced as an interactive device comprising a book of pages or a single sheet of a pliant, deformable page used by a person ordering a product or service, or seeking information about a product or service. The device responds to pressure exerted by the person on the sheet or page, and, by a signaling element in the sheet or page, sends signals, which are received by a receiver-responder in the page or in another page, or somewhere off pages of the device. The receiver-responder is configured according to the requirements of the device. In a first application of the device, the receiver-responder emits sound signals, such as pre-recorded voice signals, or music, in response to the person. In a second application of the device, the receiver-responder processes data, and may transmit the data to another location. Also the receiver responder may display an image in response to the tactile input of the person.

The present invention may be configured as an interactive menu in a restaurant, a catalog used to order a product or service, or an interactive sales aid, such as would be found on a car window in an automobile dealership. It will be understood that these aforementioned applications should not be construed as limitations to the use of the device.

### RFID

RFID (radio frequency identification) is a technology that incorporates the use of electromagnetic or electrostatic coupling in the radio frequency (RF) portion of the electromagnetic spectrum to uniquely identify an object. RFID is gaining in use in industry as an alternative to the bar code. The advantage of RFID is that it does not require direct contact or line-of-sight scanning. An RFID system consists of three components: an antenna and transceiver (often combined into one reader) and a transponder (the tag). The antenna uses radio frequency waves to transmit a signal that activates the transponder. When activated, the tag transmits data back to the antenna. The data is used to notify a programmable logic controller that an action should occur. The action could be as simple as raising an access gate or as complicated as interfacing with a database to carry out a monetary transaction. Low-frequency RFID systems (30 KHz to 500 KHz) have short transmission ranges (generally less than six feet). High-frequency RFID systems (850 MHz to 950 MHz and 2.4 GHz to 2.5 GHz) offer longer transmission ranges (more than 90 feet). In general, the higher the frequency, the more expensive the system.

### Passive RFID Tags

Passive RFID tags have no internal power supply. The minute electrical current induced in the antenna by the incoming radio frequency signal provides just enough power for the CMOS integrated circuit (IC) in the tag to power up and transmit a response. Most passive tags signal by backscattering the carrier signal from the reader. This means that the aerial (antenna) has to be designed to both collect power from the incoming signal and also to transmit the outbound backscatter signal. The response of a passive RFID tag is not just an ID number (GUID); the tag chip can contain nonvolatile EEPROM for storing data. Lack of a power supply means that the device can be quite small: commercially available products exist that can be embedded under the skin. As of 2006, the smallest such devices measured 0.15 mm×0.15 mm, and are thinner than a sheet of paper (7.5 micrometers). The addition of the antenna creates a tag that varies from the size of postage stamp to the size of a post card. Passive tags have practical read distances ranging from about 2 mm (ISO 14443) up to a few meters (EPC and ISO 18000-6) depending on the chosen radio frequency and antenna design/size. Due to their simplicity in design they are also suitable for manufacture with a printing process for the antennas. Passive RFID tags do not require batteries, can be much smaller, and have an unlimited life span.

### Semi-Passive RFID Tags

Semi-passive RFID tags are similar to passive tags except for the addition of a small battery. This battery allows the tag IC to be constantly powered, which removes the need for the aerial to be designed to collect power from the incoming signal. Aerials can therefore be optimized for the backscattering signal. Semi-passive RFID tags are thus faster in response, though less reliable and powerful than active tags.

### Active RFID Tags

Unlike passive RFID tags, active RFID tags have their own internal power source which is used to power any ICs that generate the outgoing signal. Active tags are typically much more reliable (e.g. fewer errors) than passive tags due to the ability for active tags to conduct a communications session with a reader. Active tags, with their onboard power supply, also transmit at higher power levels than passive tags, allowing them to be more effective in “RF challenged” environments, or at longer distances. Many active tags have practical ranges of hundreds of meters, and a battery life of up to 10 years. Some active RFID tags include sensors such as temperature logging. Other sensors that have been married with active RFID include humidity, shock/vibration, light, radiation, temperature and atmospherics. Active tags typically have much longer range (approximately 300 feet) and larger memories than passive tags, as well as the ability to store additional information sent by the transceiver. At present, the smallest active tags are about the size of a coin and sell for a few dollars.

### RFID Systems

In a typical RFID system, individual objects are equipped with a small, inexpensive tag. The tag contains a transponder with a digital memory chip that is given a unique electronic product code. The interrogator, an antenna packaged with a transceiver and decoder, emits a signal activating the RFID tag so it can read and write data to it. When an RFID tag passes through the electromagnetic zone, it detects the reader's activation signal. The reader decodes the data encoded in the tag's integrated circuit (silicon chip) and the data is passed to the host computer. The application software on the host processes the data, often employing Physical Markup Language (PML).

Consider, for example, securing books in a library. Security gates can detect whether or not a book has been properly checked out of the library. When users return items, the security bit is re-set and the item record in the library computer system is automatically updated. In some RFID solutions a return receipt can be generated. At this point, materials can be roughly sorted into bins by the return equipment.

### LCD

LCD (liquid crystal display) is the technology used for displays in notebook and other smaller computers. Like light-emitting diode (LED) and gas-plasma technologies, LCDs allow displays to be much thinner than cathode ray tube (CRT) technology. LCDs consume much less power than LED and gas-display displays because they work on the principle of blocking light rather than emitting it.

An LCD is made with either a passive matrix or an active matrix display display grid. The active matrix LCD is also known as a thin film transistor (TFT) display. The passive matrix LCD has a grid of conductors with pixels located at each intersection in the grid. A current is sent across two conductors on the grid to control the light for any pixel. An active matrix has a transistor located at each pixel intersection, requiring less current to control the luminance of a pixel. For this reason, the current in an active matrix display can be switched on and off more frequently, improving the screen refresh time (your mouse will appear to move more smoothly across the screen, for example). Some passive matrix LCD's have dual scanning, meaning that they scan the grid twice with current in the same time that it took for one scan in the original technology. However, active matrix is still a superior technology.

Now follows a description of a computing environment that may be used in or in conjunction with the device, in the form of IC (integrated circuit) chips, ASICs (application specific integrated circuits) of FPGAs (field programmable gate arrays.)

### Computing Environment

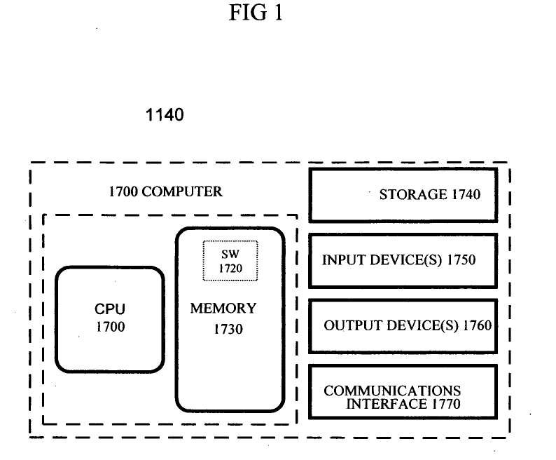

With reference to FIG. 1, control of the device may be implemented; for example, within a computing environment 1140, which includes at least one processing unit 1700 and memory 1730. In FIG. 1, this most basic configuration 1140 is included within a dashed line. The processing unit 1700 executes computer-executable instructions and may be a real or a virtual processor. In a multi-processing system, multiple processing units execute computer-executable instructions to increase processing power. The memory 1730 may be volatile memory (e.g., registers, cache, RAM), non-volatile memory (e.g., ROM, EEPROM, flash memory, etc.), or some combination of the two. The memory 1730 stores executable software—instructions and data 1720—written and operative to execute and implement the software applications required for an interactive environment supporting practice of the invention.

The computing environment may have additional features. For example, the computing environment 1140 includes storage 1740, one or more input devices 1750, one or more output devices 1760, and one or more communication connections or interfaces 1770. An interconnection mechanism (not shown) such as a bus, controller, or network interconnects the components of the computing environment. Typically, operating system software (not shown) provides an operating environment for other software executing in the computing environment, and coordinates activities of the components of the computing environment.

The storage 1740 may be removable or non-removable, and includes magnetic disks, CD-ROMs, DVDs, or any other medium which can be used to store information and which can be accessed within the computing environment. The storage 1740 also stores instructions for the software 1720, and is configured, for example, to store signal processing algorithms, database software systems, intermediate results and data generated from sensor inputs. The database includes at least one record having data related to a transmission from the device.

The input device(s) 1750 may be a touch input device such as a keyboard, mouse, pen, or trackball, a voice input device, a scanning device, or another device that provides input to the computing environment. For audio or video, the input device(s) may be a sound card, video card, TV tuner card, or similar device that accepts audio or video input in analog or digital form. The output device(s) 1760 may be a display, printer, speaker, or another device that provides output from the computing environment.

The communication interface 1770 enable the operating system and software applications to exchange messages over a communication medium with the sensor device, and servo-mechanisms in various instantiations of the apparatus of the invention. The communication medium conveys information such as computer-executable instructions, and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The communications interface 1770 is used to communicate with other devices such as cards or ATMs having RFID devices. For example, the interface 1770 may be attached to a network, such as the Internet, whereby the computing environment 1140 interchanges command, control and feedback signals with other computers, devices, and machinery.

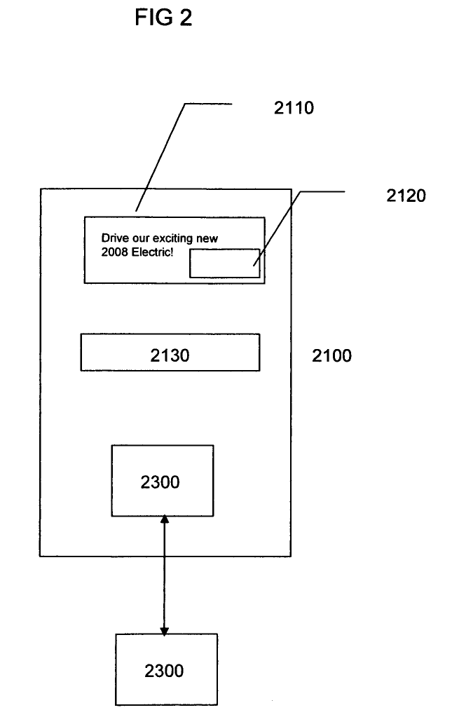

FIG. 2 illustrates the general form and configuration of the device. In FIG. 2, the device comprises a page 2100 having at least one grouping of text and/or graphics 2110. The page 2100 may be constructed of paper, plastic or laminated material. Associated with each grouping 2110, there is a pressure-sensitive transmitter 2120 that is activated by the person touching or pressing a location on the page, the location associated with the grouping 2110. The transmitter 2120 sends a first signal that identifies the grouping 2110. Also on the page, or possibly on another page, there is a receiver-responder 2300, which emits a second signal responsive to the first signal. The receiver-responder 2300 may process data or may send a signal, such as a sound or an image that is displayed or played on the output 2130.

A specific implementation of the device is now disclosed in an exemplary embodiment.

### An Exemplary Embodiment

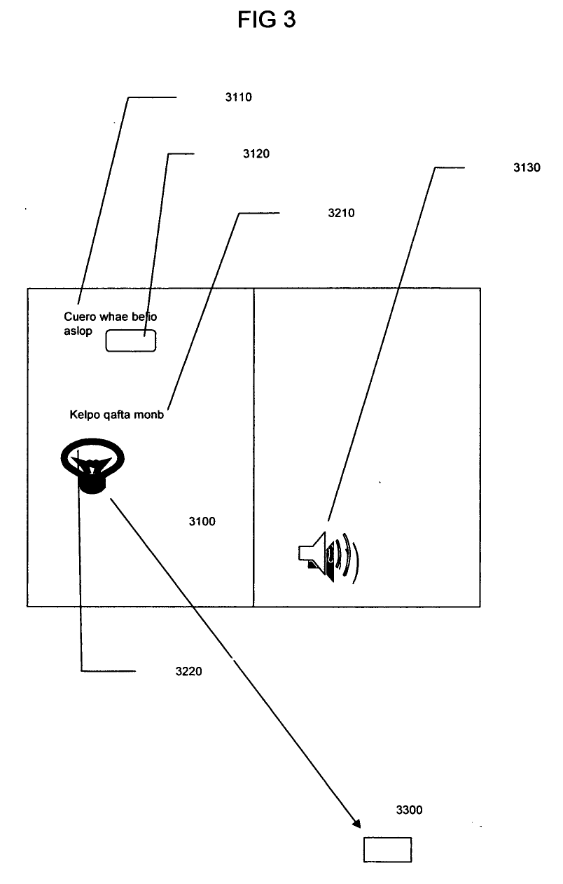

With reference to FIG. 3, an exemplary embodiment comprises a restaurant menu having at least one page 3000. The page has text and/or graphics 3110, which may describe an item for sale. Associated with the text or graphics 3110 there is at least one first type transmitter 3120 embedded in the page 3000. The first type transmitter 3120 is activated by touch or pressure. When touched or pressed, the first type transmitter 3120 sends a first signal, which is received by a sound generator 3130, which emits a sound associated with the first signal. For example, the text or graphics 3110 describe a dish or food for sale in a restaurant. The diner reads the description 3110 and wanting more information presses an area of the menu 3000 wherein is embedded the first type transmitter 3120. The first type transmitter 3120 sends a signal to the sound generator 3130, which further describes the item for sale. When ready to order the diner presses an area of the menu associated with a second text or graphics 3210. The area pressed by the diner activates a second type transmitter 3220, which sends a second signal to a second receiver 3300, which creates a data entry associated with the diner's order.

With reference to FIG. 3, the secondary receiver 3300 may further transmit the data entry, which for example, is an order placed by the diner. Data sent by the secondary receiver 3300 may be used to complete the order. The secondary receiver 3300 may be off the menu and connected to a computer network or system

### DISCLOSURE SUMMARY

An interactive page, such as found in a book or in a menu has been disclosed. The page is capable of interacting with a person by responding to tactile presses, and reacts by displaying an image or sound. In an exemplary embodiment, a restaurant menu is disclosed and other applications of the invention are disclosed. The true scope and extent of the inventive concept are defined by the claims that follow.

What is claimed is:

1. A pliant sheet having matter printed thereupon, the printed matter including a price related to the matter, the sheet having
a first device that when touched transmits a first signal related to the printed matter, the first signal encoding sound related to the printed matter, and;
a second device that when touched transmits a second signal related to the printed matter, the second signal encoding an order for the printed matter.
